(19) United States
(12) Patent Application Publication
(10) Pub. No.: US 2016/0212967 A1
(43) Pub. Date: Jul. 28, 2016

(54) WASTE ELIMINATION APPARATUS

(71) Applicants: Randy Giles, Fort Worth, TX (US); Danny Terrell, Fort Worth, TX (US)

(72) Inventors: Randy Giles, Fort Worth, TX (US); Danny Terrell, Fort Worth, TX (US)

(21) Appl. No.: 15/009,433

(22) Filed: Jan. 28, 2016

Related U.S. Application Data
(60) Provisional application No. 62/108,672, filed on Jan. 28, 2015.

(51) Int. Cl. A01K 1/01

(52) U.S. Cl. CPC A01K 1/01

(57) ABSTRACT

The present disclosure provides a waste elimination apparatus. The waste elimination apparatus, in one configuration, includes a conduit having a first end and a second opposing end defined by a length (l_{c}). The waste elimination apparatus, in this configuration, further includes a user operable valve coupled to the first end, the user operable valve configured to couple to a liquid source, and a waste elimination fixture coupled to the second opposing end in fluid communication with the user operable valve. The waste elimination fixture, in this configuration, includes an enclosure, wherein the enclosure is configured to at least partially surround animal waste, and a spray feature located within the enclosure in fluid communication with the user operable valve, the spray feature having one or more holes configured to concentrate liquid provided by the liquid source via the user operable valve upon the animal waste.

### CROSS-REFERENCE TO RELATED APPLICATION

This application claims the benefit of U.S. Provisional Application Ser. No. 62/108,672 filed on Jan. 28, 2015, by Randy Giles, et al., entitled “Undoo”, commonly assigned with the present disclosure and incorporated herein by reference.

### TECHNICAL FIELD

The present disclosure is directed, in general to a waste elimination apparatus and more specifically, to a waste elimination apparatus configured to couple to a pressured fluid source.

### BACKGROUND

Pets, and especially dogs, are important additions to the family household. However, cleaning up after a pet is an onerous task for many. In particular, picking up and disposing of pet waste is an unsettling task that must be done to keep lawns, sidewalks, and streets clean. Pet owners that live in cities and suburban areas are mandated by laws and local ordinances to clean up after their dogs by immediately removing waste from sidewalks and lawns. Owners that live in less populated areas, often have to remove waste in order to keep their front and backyards well kept and clean. Many pet owners collect waste in either a plastic or paper bag. Collecting waste by hand even with the use of a plastic bag is an unsanitary and disagreeable chore. In most cases, pet owners do not wish to manually handle pet waste.

Accordingly, what is needed in the art is an apparatus that eliminates pet waste without the need for manual handling thereof.

### SUMMARY

To address the above-discussed deficiencies of the prior art, the present disclosure provides a waste elimination apparatus. The waste elimination apparatus, in one configuration, includes a conduit having a first end and a second opposing end defined by a length (l_{c}). The waste elimination apparatus, in this configuration, further includes a user operable valve coupled to the first end, the user operable valve configured to couple to a liquid source, and a waste elimination fixture coupled to the second opposing end in fluid communication with the user operable valve. The waste elimination fixture, in this configuration, includes an enclosure, wherein the enclosure is configured to at least partially surround animal waste, and a spray feature located within the enclosure in fluid communication with the user operable valve, the spray feature having one or more holes configured to concentrate liquid provided by the liquid source via the user operable valve upon the animal waste.

The foregoing has outlined preferred and alternative features of the present disclosure so that those skilled in the art may better understand the detailed description of the disclosure that follows. Additional features of the disclosure will be described hereinafter that form the subject of the claims of the disclosure. Those skilled in the art should appreciate that they can readily use the disclosed conception and specific embodiment as a basis for designing or modifying other structures for carrying out the same purposes of the present disclosure. Those skilled in the art should also realize that such equivalent constructions do not depart from the spirit and scope of the disclosure.

### BRIEF DESCRIPTION

For a more complete understanding of the present disclosure, reference is now made to the following descriptions taken in conjunction with the accompanying drawings, in which:

FIG. 1 illustrates a waste elimination apparatus in accordance with one embodiment of the disclosure;

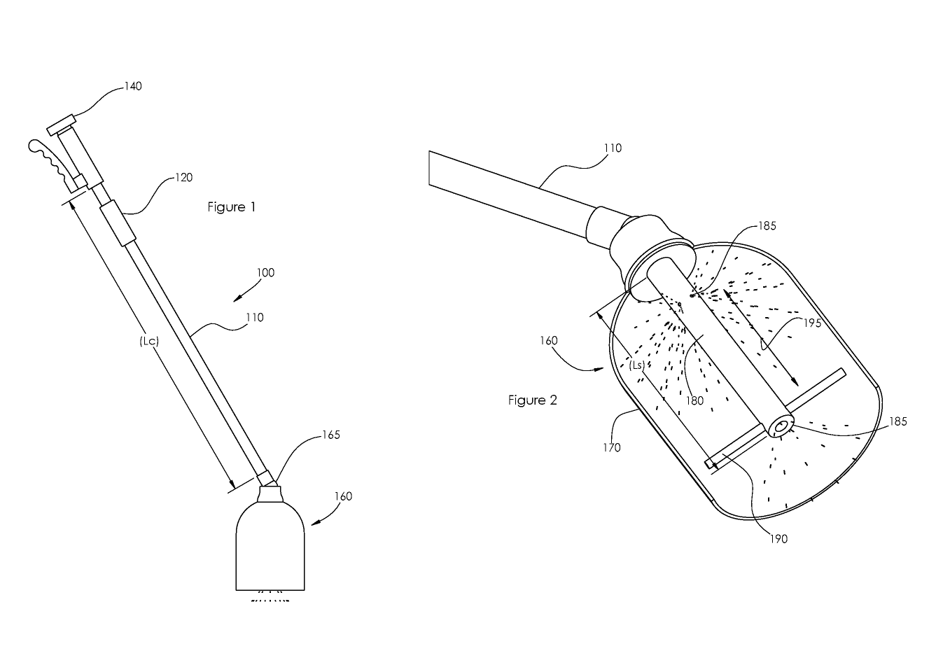

FIG. 2 illustrates an exploded view of the waste elimination fixture of FIG. 1;

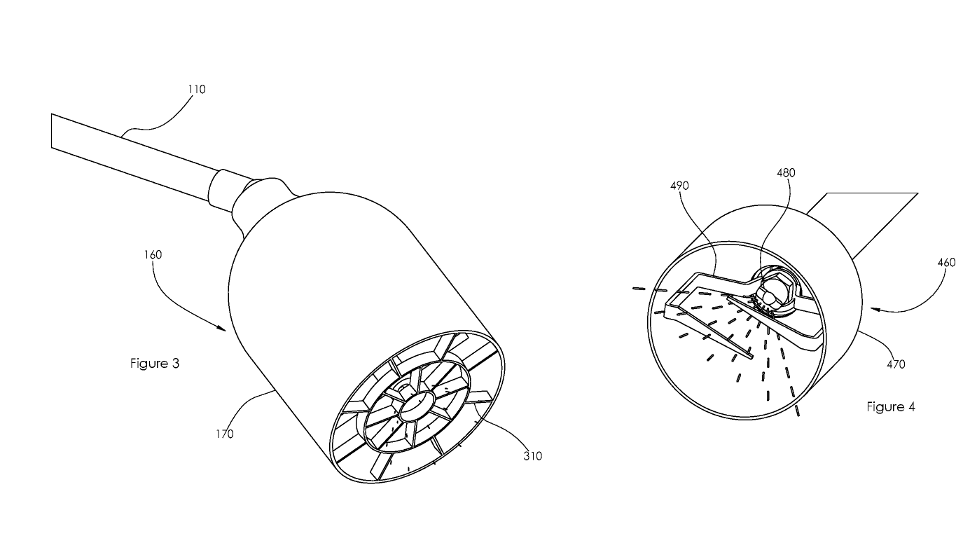

FIG. 3 illustrates the waste elimination fixture of FIGS. 1 and 2 having a grate; and

FIG. 4 illustrates an alternative embodiment of a waste elimination fixture manufactured in accordance with the disclosure.

### DETAILED DESCRIPTION

Referring initially to FIG. 1, illustrated is a waste elimination apparatus 100 in accordance with one embodiment of the disclosure. The waste elimination apparatus 100 initially includes a conduit 110. The conduit 110 may be any conduit in accordance with the disclosure, including conduits made of metal and/or plastic, among other usable materials. In the embodiment of FIG. 1, the conduit 110 is a metal pipe.

The length (l_{c}) of the conduit 110 may vary from design to design. However, it is generally desirable that the length (l_{c}) of the conduit 110 be sufficient for a user to grip one end of the conduit 110 in his/her hand, and have the other end of the conduit 110 reach the ground without the user having to reach over significantly. For example, it is generally desirable that the length (l_{c}) of the conduit 110 be at least about 24 inches, and in certain instances at least about 36 inches. In yet another embodiment, the length (l_{c}) of the conduit 110 is at least about 42 inches. While the length (l_{c}) of the conduit 110 is fixed in the embodiment of FIG. 1, other embodiments exist where the length (l_{c}) of the conduit 110 telescopes to accommodate different user heights.

Coupled to the conduit 110 in the embodiment of FIG. 1 is a handgrip 120. The handgrip 120 may have a variety of different purposes. First, the handgrip 120 may provide a gripping point for the user of the waste elimination apparatus 100. In this scenario, the handgrip 120 should be ergonomically positioned for an average user. In certain embodiments, the handgrip 120 is not fixed, but movable, and thus can accommodate a wide range of different users. In other embodiments, however, the handgrip 120 is fixed. Second, as discussed in greater detail below, the handgrip 120 may also function as a mechanical agitator for the chopping feature 190 of the waste elimination fixture 160.

The handgrip 120 may comprise a variety of different materials and remain within the purview of the present disclosure. In one embodiment, the handgrip 120 comprises rubber. In yet another embodiment, however, the handgrip 120 comprises plastic, or even foam, among other materials. In the embodiment of FIG. 1, the handgrip 120 comprises a semi-rigid foam type material, but should not be limited to such.

Coupled to a first end of the conduit 110, in the embodiment of FIG. 1, is a user operable valve 140. The user operable valve 140, in accordance with this embodiment, is configured to regulate the amount, and pressure, of fluid provided to the conduit 110. For example, in the embodiment wherein the user operable valve 140 is coupled to a standard water hose, the user operable valve 140 could regulate the amount, and pressure, of the water provided to the conduit 110.

In such a water hose based configuration, the user operable valve 140 might have a United States “GHT” thread standard (e.g., ¾″ diameter straight (non-tapered) thread with a pitch of 11.5 TPI) or Foreign “BSP” thread standard (e.g., ¾″ diameter straight (non-tapered) thread with a pitch of 14 TPI) for coupling to a standard United States or Foreign garden hose, respectively. Alternatively, the user operable valve 140 might employ a quick-connector system for coupling to the pressurized liquid source.

A variety of different user operable valves 140 might be used and remain within the scope of the present disclosure. In the embodiment of FIG. 1, the user operable valve 140 is a hand-operated valve, such that a user of the waste elimination apparatus 100 might use his/her hand to squeeze varying amounts and thereby regulate the amount, and pressure, of fluid provided to the conduit 110. In this embodiment, the more the user compresses the hand-operated valve, the greater amount of fluid that is provided to the conduit 110, and the less the user compresses the hand-operated valve, the less amount of fluid that is provided to the conduit 110. In this embodiment, when the user completely releases the hand-operated valve, a spring therein automatically closes the user operable valve 140. In yet another embodiment, a thumb operates valve is used. In yet other embodiments, even different types of valves are used. Accordingly, the present disclosure should not be unnecessarily limited to a particular type of user operable valve 140.

Coupled to a second opposing end of the conduit 110 is a waste elimination fixture 160. The waste elimination fixture 160, in accordance with the disclosure, is in fluid communication with the user operable valve 140. Accordingly, the waste elimination fixture 160 is in fluid communication with any liquid that might be provided by the pressurized liquid source.

In the embodiment of FIG. 1, the waste elimination fixture 160 is positioned on a swivel 165, thereby allowing the waste elimination fixture 160 to move in relation to the conduit 110. In the embodiment shown, the waste elimination fixture 160 is positioned at an angle with respect to the conduit 110. In other embodiments, the waste elimination fixture 160 is configured to remain in-line with the conduit 110. Additionally, the waste elimination fixture 160 might be rigidly fixed with respect to the conduit 110, for example in a position in-line with the conduit 110.

Turning to FIG. 2, illustrated is an exploded view of the waste elimination fixture 160 of FIG. 1. The waste elimination fixture 160 of FIG. 2 initially includes an enclosure 170. The enclosure 170, in accordance with the present disclosure, is configured to at least partially surround animal waste (e.g., animal fecal matter). In one particular embodiment of the disclosure, the enclosure 170 is appropriately sized to fully surround animal waste that might be positioned in grass, dirt, concrete, etc. To accommodate this, the enclosure 170 might comprise a bowl. For example, the enclosure 170 of the embodiment of FIG. 1 comprises a plastic bowl. Notwithstanding, the enclosure 170 may comprise other shapes and materials without departing from the scope of the present disclosure.

Located within the enclosure 170 of the waste elimination fixture 160 in the embodiment of FIG. 2 is a spray feature 180. In the embodiment of FIG. 2, the spray feature 180 is in fluid communication with the user operable valve 140, for example by way of the conduit 110. The spray feature 180 may comprise a variety of different lengths, shapes, etc. In one embodiment, the spray feature 180 is a short stub that only extends a short distance into the enclosure 170. In yet another embodiment, as shown in the embodiment of FIG. 2, the spray feature is a shaft extending into the enclosure 170 by a length (lₛ). The length (lₛ) may vary, but most embodiments have it being less than about 8 inches.

In accordance with the disclosure, the spray feature 180 has one or more holes 185, the one or more holes 185 configured to concentrate liquid provided by the pressurized liquid source upon the animal waste. The one or more holes 185 may be placed at a variety of different locations and remain within the purview of the present disclosure. In one embodiment, at least one of the one or more holes 185 is located in the tip of the spray feature 185. According to this embodiment, the hole located in the tip of the spray feature 185 might focus the liquid directly on the animal waste, and thereby act as a high-pressure jet. In yet another embodiment, at least one of the one or more holes 185 might be located on a side of the spray feature 180, particularly when the spray feature 180 comprises the aforementioned shaft. According to this embodiment, the hole located on a side of the spray feature 185 might spray the liquid upon an inside wall of the enclosure 170, and thereafter be redirected toward, or drip down upon, the animal waste. In yet another embodiment, a combination of the aforementioned embodiments is used. As those skilled in the art may now appreciate, any number of holes 185 may be located in the spray feature 180.

The waste elimination fixture 160 of the embodiment of FIG. 2 further includes a chopping feature 190. The chopping feature 190, in the embodiment of FIG. 2, extends away from the spray feature 180. Any number of chopping features 190 may be used and remain within the purview of the present disclosure. It is believed that somewhere between two and six chopping features 190 are optimal. Nevertheless, other workable embodiments outside of this range have been achieved.

The chopping features 190 illustrated in the embodiment of FIG. 2 comprise blades. For example, in one embodiment, the chopping features 190 comprise metal blades, as might be used in a lawnmower. Nevertheless, the chopping features 190 might also comprise tines, among other materials, and remain within the scope of the present disclosure.

The chopping features 190, in accordance with the disclosure, are configured to rotate about the spray feature 180 and thereby mulch the animal waste. Specific to one embodiment, the chopping features 190 rotate, and thereby mulch the animal waste, while the spray feature 180 concentrates liquid on the animal waste. In this embodiment, the spray feature 180 and the chopping feature 190 rotate in unison. In accordance with the disclosure, the rotation may be in a single direction, or alternatively may be a back and forth (e.g., clockwise then counterclockwise, or vice-versa) motion.

The rotation of the chopping feature 190 may be achieved in various different ways. In one embodiment, the pressurized liquid supplied by the conduit 110 works to rotate the chopping feature 190. In this embodiment, the waste elimination fixture 160 might include a propeller that is driven by the pressurized liquid supply, which in turn rotates the chopping feature 190. In yet another embodiment, the one or more holes 185 are strategically placed to cause the chopping feature 190 to rotate when fluid exits therefrom. In yet another embodiment, the chopping feature 190 is mechanically rotated. For example, the user of the waste elimination apparatus 100 might pump the handgrip 120, which might in turn rotate the chopping feature 190 by way of a cam system or otherwise.

In additional to the chopping feature 190 being configured to rotate, the chopping feature 190 may additionally be designed to move up and down, as illustrated by the arrow 195. In this embodiment, the chopping feature 190 would be configured to move up and down at least partially along the length (lₛ). This rotational and up and down action of the chopping feature 190 improves the waste elimination apparatus' 100 efficiency in eliminating the animal waste.

A waste elimination apparatus, such as the waste elimination apparatus 100 illustrated in FIGS. 1 and 2, is specifically designed to conveniently eliminate animal waste. To employ the waste elimination apparatus, a user of a waste elimination apparatus would initially attach the user operable valve to a pressurized fluid source, such as a conventional water hose. The user of the waste elimination apparatus would then find a pile of animal waste and place the enclosure thereover. Thereafter, the user of the waste elimination apparatus would open the user operable valve, thereby concentrating liquid provided by the liquid source upon the animal waste. Optionally, the user of the waste elimination apparatus could simultaneously cause the chopping feature to rotate and/or move up and down. In this scenario, the combination of the liquid and the chopping motion would eliminate the animal waste. Thereafter, the user of the waste elimination apparatus could move to another pile of animal waste, and begin again.

A waste elimination apparatus, such as the waste elimination apparatus 100 of FIG. 1, have many advantages. First, it is highly efficient at eliminating solid animal waste. In doing so, it had the added advantage of adding nutrients to the soil. Second, the waste elimination apparatus allows users thereof to maintain a safe working distance from the animal waste, and therefor users of the waste elimination apparatus do not come in close contact with the waste elimination apparatus. Third, the waste elimination apparatus is a self-cleaning device, thereby requiring very little maintenance. Additionally, the waste elimination apparatus eliminates the use, and therefor disposal, of conventional plastic bags.

Turning briefly to FIG. 3, illustrated is the waste elimination fixture 160 of FIGS. 1 and 3 having a grate 310. The grate 310, in the embodiment shown, is configured to further separate the animal waste into smaller pieces when the waste elimination apparatus 100 is first pressed upon the animal waste. Accordingly, among other positions, the grate 310 could be placed at the bottom of the enclosure 170. Those skilled in the art understand the variety of different configurations the grate 310 may have while achieving the same purpose.

Turning now to FIG. 4, illustrated is an alternative embodiment of a waste elimination fixture 460 manufactured in accordance with the disclosure. Of first note, the waste elimination fixture 460 is inline with its conduit. As discussed above, certain embodiments benefit from such a configuration. Furthermore, the waste elimination fixture 460 has a much shorter spray feature 480. Accordingly, in the embodiment of FIG. 4, only a single hole 485 (e.g., a high pressure jet nozzle) is associated with the spray feature 480.

The waste elimination fixture 460 of FIG. 4 further employs a different setup for its chopping feature 490. The chopping feature 490 illustrated in FIG. 2 uses only two metal chopping blades. Furthermore, rather than being straight features, such as show in the previous embodiments, the metal chopping blades of the chopping feature 490 initially extend away from the spray feature 480, then down from the spray feature 480, and then back toward the center of the enclosure 470 before crossing paths with one another by a predetermined distance. It is believed that the setup shown in FIG. 4 may provide superior results as compared to the other embodiments. Nonetheless, the present disclosure should not be unintentionally limited to such a design.

Although the present disclosure has been described in detail, those skilled in the art should understand that they can make various changes, substitutions and alterations herein without departing from the spirit and scope of the disclosure it its broadest form.

What is claimed is:

1. A waste elimination apparatus, comprising:
a conduit having a first end and a second opposing end defined by a length (l_{c});
a user operable valve coupled to the first end, the user operable valve configured to couple to a pressurized liquid source;
a waste elimination fixture coupled to the second opposing end in fluid communication with the user operable valve, the waste elimination fixture including:
an enclosure, wherein the enclosure is configured to at least partially surround animal waste;
a spray feature located within the enclosure in fluid communication with the user operable valve, the spray feature having one or more holes configured to concentrate liquid provided by the pressurized liquid source via the user operable valve upon the animal waste.

2. The waste elimination apparatus of claim 1, wherein at least one of the one or more holes is positioned in a tip of the spray feature, thereby focusing the liquid directly on the animal waste.

3. The waste elimination apparatus of claim 2, wherein a chopping feature extends from the spray feature, the chopping feature configured to chop the animal waste.

4. The waste elimination apparatus of claim 3, wherein the at least one hole and the chopping feature are configured to rotate in unison.

5. The waste elimination apparatus of claim 3, wherein the chopping feature and spray feature are configured to chop and spray the animal waste, respectively, simultaneously.

6. The waste elimination apparatus of claim 3, wherein the chopping feature is configured to be manually rotated.

7. The waste elimination apparatus of claim 6, wherein a grip on the conduit is configured to manually rotate the chopping feature.

8. The waste elimination apparatus of claim 3, wherein the chopping feature is a first chopping feature, and further including a second chopping feature opposing the first chopping feature.

9. The waste elimination apparatus of claim 8, wherein the first and second chopping features are blades.

10. The waste elimination apparatus of claim 1, wherein the spray feature is a high-pressure jet.

11. The waste elimination apparatus of claim 1, wherein the spray feature is a shaft extending into the enclosure by a length (lₛ), the shaft having the one or more holes.

12. The waste elimination apparatus of claim 11, wherein at least one of the one or more holes is positioned in a tip of the shaft, thereby focusing the liquid directly on the animal waste.

13. The waste elimination apparatus of claim 11, wherein at least one of the one or more holes is positioned along the length (lₛ) of the shaft, thereby focusing the liquid toward an inner surface of the enclosure.

14. The waste elimination apparatus of claim 11, wherein at least one of the one or more holes is positioned in a tip of the shaft, thereby focusing the liquid directly on the animal waste, and another of the at least one of the one or more holes is positioned along the length (lₛ) of the shaft, thereby focusing the liquid toward an inner surface of the enclosure.

15. The waste elimination apparatus of claim 11, wherein a chopping feature extends from the shaft, the chopping feature configured to chop the animal waste.

16. The waste elimination apparatus of claim 15, wherein the chopping feature is a blade.

17. The waste elimination apparatus of claim 15 wherein the chopping feature is a tine.

18. The waste elimination apparatus of claim 15, wherein the chopping feature is configured to move up and down at least partially along the length (lₛ).

19. The waste elimination apparatus of claim 1, wherein the enclosure is a plastic enclosure.

20. The waste elimination apparatus of claim 1, wherein the user operable valve is a hand-operated valve.
